(19) United States
(12) Patent Application Publication
(10) Pub. No.: US 2007/0226138 A1
(43) Pub. Date: Sep. 27, 2007

(54) Systems and methods for subscriber to payee cross pollination

(76) Inventors: Adam Koltnow, Delaware, OH (US); Howard Baulch, Dublin, OH (US); Blake Keown, Lewis Center, OH (US); Peter Moenickheim, Dublin, OH (US)

Correspondence Address: SUTHERLAND ASBILL & BRENNAN LLP, 999 PEACHTREE STREET, N.E., ATLANTA, GA, 30309, US

(21) Appl. No.: 11/386,263

(22) Filed: Mar. 22, 2006

(51) Int. Cl. G06Q 40/00; H04M 15/00; G07F 19/00

(52) U.S. Cl. 705/40; 705/39; 705/34

(57) ABSTRACT

Systems and methods for processing subscriber and payee information include storing information identifying a first subscriber of an electronic payment service, and receiving information identifying an intended payee from a second subscriber. A determination is then made that the first subscriber and the intended payee of the second subscriber are the same entity. Such a determination may be confirmed and/or verified in a variety of ways. If confirmed, a payment may be made on behalf of the second subscriber to the first subscriber, now identified as a payee.

### FIELD OF THE INVENTION

The present invention relates to electronic commerce, and more particularly to payee management in an electronic payment service.

### BACKGROUND OF THE INVENTION

A financial institution such as a bank, savings and loan, credit union, or brokerage house is an entity that maintains financial accounts that can be debited and/or credited as a result of transaction activity. Networks linking financial institutions, as well as other entities, include the Federal Reserve's Automated Clearinghouse (ACH) network, MasterCard'® RPPS network, Visa's® ePay network, and Princeton's® eCom network. The Federal Reserve system is the central bank of the United States of America, formed by an act of Congress. It consists of twelve Reserve Banks located in major cities throughout the United States. The ACH network electronically links the Federal Reserve Banks with financial institutions throughout the United States to support electronic funds transfer between the financial institutions. The RPPS, ePay, and eCom networks are examples of third party remittance networks, each of which may communicate with an electronic payment service provider.

An electronic payment service provider is an entity that completes payment on behalf of a subscriber of that service provider. The subscriber on whose behalf a payment is completed is considered a payor, and an entity receiving the payment from the electronic payment service provider (often a third party biller) is a payee. A subscriber may be an individual, a business, or another type of entity/organization. The electronic payment service provider maintains information associated with its subscribers, including information identifying each subscriber and information identifying one or more payment accounts belonging to each subscriber.

In a typical operation a payment service provider receives a payment request electronically, either directly from a subscriber, or from another entity acting on behalf of a subscriber. The payment request specifies at least a payor, a payee, and a payment amount. A payment date is also typically included, although it can be assumed to be “as soon as possible” if omitted. After receipt of a payment request, a payment service provider processes the request to complete the payment. At the conclusion of payment processing the electronic payment service provider issues remittance to a payee (often in the form of a credit to the payee) and a description of a credit that allows proper payment posting to a specific account, or sub-account, in a payee's Accounts Receivable ledger.

A credit accomplishes a transfer of funds to a payee to fulfill a payment request and may be performed through a paper process (check or draft), or an electronic funds transfer (EFT) process. The funds may come directly from a demand deposit account associated with a subscriber (e.g., a checking account, a savings account, a money market account, etc.), or from a demand deposit account associated with the payment service provider. A check is drawn against an account associated with the payment service provider, while a draft is drawn against an account associated with the subscriber. The description accompanying the credit typically includes at least information identifying a subscriber and may include information identifying the subscriber's account with the payee. A payment to a payee that is not an electronic payee is completed by a paper (check or draft) payment.

An electronic biller is a biller that presents at least one of its bills for a customer of an electronic biller, electronically, either directly or through a biller service provider (BSP). A biller service provider is an entity that electronically presents bills to customers of an electronic biller on behalf of the electronic biller. A biller service provider may also be an electronic payment service provider. Such service providers are known as electronic billing and payment (EBP) service providers. Electronic bill presentment can be via any one of several electronic user interfaces, including Web-based interfaces, PC application-based interfaces, PDA-based interfaces, mobile phone-based interfaces, and set-top box-based interfaces.

Most electronic payment service providers require a payee set-up process for a particular payee to be completed before the electronic payment service provider will pay that particular payee. Part of the payee set-up process includes an electronic payment service provider determining if the payee is a payee about whom an electronic payment service provider has information that enables remittance associated with that payee to be handled in some improved/optimal fashion. Based upon information provided by the subscriber the electronic payment service provider accesses a payee database and determines if the subscriber-identified payee is included therein. Although an electronic payment service provider often has financial information about subscribers, (e.g., billing address, demand deposit account number, etc.) the majority of subscribers are not also electronic payees. Those subscribers that are not electronic payees may be paid through the electronic payment service provider's service by other subscribers to the same electronic payment service provider who are also electronic payees. Such payments would be issued as paper payments.

Although a majority of payments may be made electronically, the majority of all questioned payments (i.e., claims) result from paper payments. Further, as will be understood by one of ordinary skill in the art, an electronic funds transfer is less costly to an electronic payment service provider than a paper payment due to lower operational processing costs. Thus, electronic payments have the dual benefits of operational processing cost reduction and claims reduction as compared to paper payments. Therefore improving the electronic payment rate (the number of payments made electronically) would reduce costs and claims associated with providing the electronic payment service. Accordingly, a need exists for a technique to increase the electronic payment rate.

### SUMMARY OF THE INVENTION

According to an embodiment of the invention, there is disclosed a method for processing payee information that includes storing information identifying a first subscriber of an electronic payment service; receiving, from a second subscriber, information identifying an intended payee of the second subscriber; determining that the first subscriber and the intended payee of the second subscriber are the same entity; and converting the first subscriber to an electronic payee.

According to one aspect of the invention, determining that the first subscriber and the intended payee of the second subscriber are the same entity is based upon at least a portion of the stored first subscriber identifying information matching at least a portion of the received payee identifying information. According to another aspect of the invention the method further includes normalizing the received payee information prior to determining that the first subscriber and the intended payee of the second subscriber are the same entity. In accordance with yet another aspect of the invention the method further includes confirming the determination that the first subscriber and the intended payee of the second subscriber are the same entity with the second subscriber. According to another aspect of the invention the method further includes verifying the determination that the first subscriber and the intended payee of the second subscriber are the same entity with the payee. In accordance with yet another aspect of the invention, the verification includes identifying a deposit account to credit electronically.

According to yet another aspect of the invention the method further includes receiving a request to pay the intended payee on behalf of the second subscriber; and issuing an instruction to electronically credit a deposit account based upon the stored first subscriber information. In accordance with another aspect of the invention, the request is received from a consumer service provider associated with the second subscriber. According to yet another aspect of the invention, the payee information and the request are received together. In accordance with yet another aspect of the invention, determining that the first subscriber and the intended payee of the second subscriber are the same entity includes receiving the information identifying an intended payee and identifying the first subscriber as a candidate match to the intended payee, requesting a confirmation of the acceptability of converting the first subscriber to an electronic payee, and receiving the confirmation of the acceptability of converting the first subscriber to an electronic payee. According to another aspect of the invention, requesting and receiving a confirmation that the first subscriber and the payee are the same entity occurs in parallel with directing an initial credit to a deposit account.

According to another embodiment of the invention there is disclosed a method for processing subscriber information of the payment service provider that includes storing information identifying a first subscriber of an electronic payment service provider; requesting a confirmation of the acceptability of converting the first subscriber to an electronic payee; receiving the confirmation of the acceptability of converting the first subscriber to an electronic payee; and after receiving the confirmation, converting the first subscriber to an electronic payee.

According to one aspect of the invention the method further includes sending electronic payments on behalf of a second subscriber to the electronic payee. According to another aspect of the invention, receiving the confirmation of the acceptability of converting the first subscriber to an electronic payee includes receiving the confirmation from a third party consumer identity service. In accordance with yet another aspect of the invention the method further includes associating a deposit account with the electronic payee. According to yet another aspect of the invention, requesting and receiving a confirmation that the first subscriber and the payee are the same entity occurs in parallel with directing an initial credit to the deposit account. In accordance with another aspect of the invention, receiving the confirmation of the acceptability of converting the first subscriber to an electronic payee includes verifying the acceptability of converting the first subscriber to an electronic payee with the first subscriber. According to yet another aspect of the invention, verifying includes identifying a deposit account to credit electronically.

According to yet another embodiment of the invention there is disclosed a system for processing payee information that includes a memory configured to store information identifying a first subscriber of an electronic payment service; and a processor configured to receive, from a second subscriber, information identifying an intended payee of the second subscriber. The processor contains programmed logic to execute software instructions for determining that the first subscriber and the intended payee are the same entity, and converting the first subscriber to an electronic payee.

According to one aspect of the invention the memory comprises a subscriber profile database, a managed payee database, and/or a subscriber/payee database. According to another aspect of the invention, the determination that the first subscriber and the intended payee are the same entity is made based upon at least a portion of the stored first subscriber identifying information matching at least a portion of the received payee identifying information. In accordance with yet another aspect of the invention, the received payee information is normalized prior to determining that the first subscriber and the intended payee are the same entity. According to yet another aspect of the invention, the processor contains software instructions for receiving a confirmation that the first subscriber and the intended payee are the same entity from the second subscriber. In accordance with another aspect of the invention, the processor contains software instructions for verifying the determination that the first subscriber and the intended payee are the same entity with the payee. According to yet another aspect of the invention, the verifying includes identifying a deposit account to credit electronically.

In accordance with yet another aspect of the invention, the software instructions for determining that the first subscriber and the intended payee are the same entity executed by the processor include receiving the information identifying an intended payee, identifying the first subscriber as a candidate match to the intended payee, requesting a confirmation of the acceptability of converting the first subscriber to an electronic payee, and receiving the confirmation of the acceptability of converting the first subscriber to an electronic payee. According to another aspect of the invention, the stored first subscriber information comprises information identifying a deposit account associated with the first subscriber and the received information identifying an intended payee of the second subscriber excludes information identifying the deposit account, and wherein the processor comprises software instructions for receiving a request for the payment service provider to pay the payee on behalf of the second subscriber, and issue an instruction to electronically credit the deposit account based upon the stored first subscriber information. In accordance with yet another aspect of the invention, the request is received from a consumer service provider associated with the second subscriber. According to yet another aspect of the invention, the payee information and the request are received together.

### BRIEF DESCRIPTION OF THE DRAWINGS

Having thus described the invention in general terms, reference will now be made to the accompanying drawings, which are not necessarily drawn to scale, and wherein:

FIG. 1 depicts an electronic payment network in accordance with certain aspects of the present invention.

FIG. 2 is a block diagram of a computing system associated with an electronic service provider in accordance with certain aspects of the present invention.

FIG. 3 depicts a typical user interface for payee set-up in accordance with certain aspects of the present invention.

FIG. 4 is a flow diagram of operations performed by the computing system associated with an electronic service provider in accordance with certain aspects of the present invention.

FIG. 5 is a flow diagram of other operations performed by the computing system associated with an electronic service provider in accordance with certain aspects of the present invention.

FIG. 6 is a flow diagram of still other operations performed by the computing system associated with an electronic service provider in accordance with certain aspects of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention is directed to systems and methods for processing payee information that includes storing information identifying a first subscriber of an electronic payment service, and receiving information identifying an intended payee from a second subscriber. A determination is then made that the first subscriber and the intended payee of the second subscriber are the same entity and the results of that determination are stored.

The present invention is described below with reference to figures and flowchart illustrations of systems, methods, apparatuses and computer program products according to embodiments of the invention. It will be understood that each block of the flowchart illustrations, and combinations of blocks in the flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory are incorporated in an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions. The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network.

The present invention will now be described more fully hereinafter with reference to the accompanying figures, in which like numerals indicate like elements throughout the several drawings. Some, but not all embodiments of the invention are described. Indeed, these inventions may be embodied in many different forms and should not be construed as limited to the embodiments set forth herein; rather, these embodiments are provided so that this disclosure will satisfy applicable legal requirements.

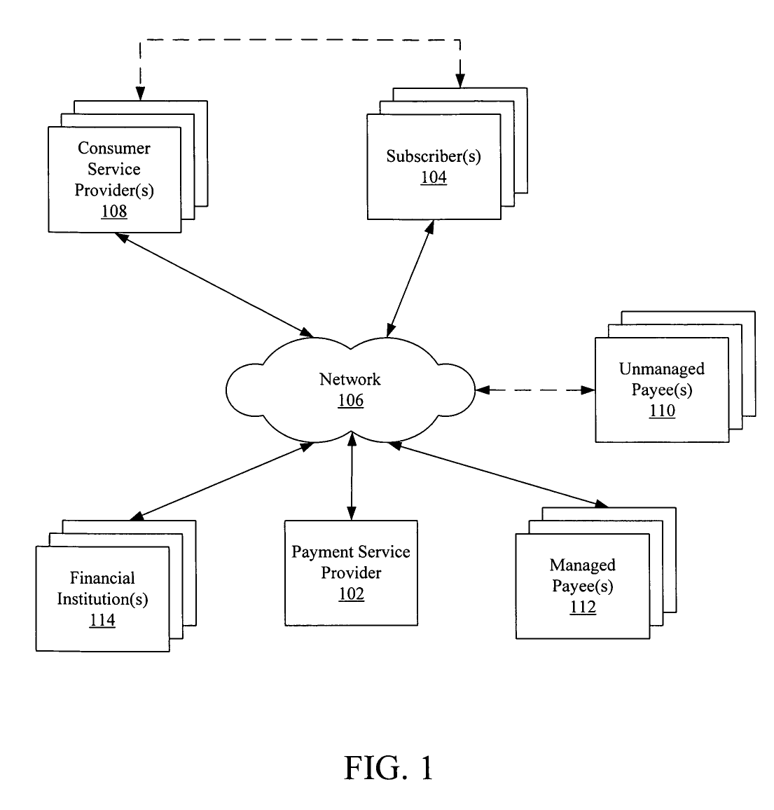

FIG. 1 depicts a payment service provider 102 capable of providing at least an electronic payment service to one or more subscribers 104. In alternative embodiments of the invention, the payment service provider 102 may also provide an electronic bill presentment service (e.g., a biller service provider), as well as other electronic commerce services. Thus, the payment service provider 102 may be an electronic billing as well as payment service provider.

Subscribers 104 communicate with the service provider 102 via a network 106. The network 106 may be, for example, the Internet, though it could be another public network, or even a private network. Further, the network 106 may be comprised of multiple interconnected networks. A subscriber 104, in some instances, communicates directly with the payment service provider 102. In other instances, a subscriber 104 communicates with the payment service provider 102 through one of consumer service providers 108.

A consumer service provider 108 is an entity that offers a payment service directly to certain ones of subscribers 104 (indicated in FIG. 1 by the dotted line connecting the subscriber 104 to the consumer service provider 108), while the payment service provider 102 provides some supporting functionality, i.e., payment processing and remittance issuance, of completing payments. A consumer service provider 108 may also be referred to as a sponsor. A consumer service provider 108 may present a payment service user interface to a subscriber 104 to provide information to, and receive information from, a subscriber 104. In such instances, the consumer service provider 108 receives information from the payment service provider 102, via the network 106, and then presents such to a subscriber 104. Likewise in such instances, a consumer service provider 108 receives information from a subscriber 104, and then passes such to the payment service provider 102 via the network 106. Communications between a subscriber 104 and a consumer service provider 108 can, as desired, be via the network 106, via another network, or otherwise. In other situations in which a consumer service provider 108 offers the payment service, the payment service provider 102 provides a payment service user interface directly to a subscriber 104, via the network 106, that may be branded (or presented to the subscriber 104) as belonging to a consumer service provider 108.

Also shown in FIG. 1 are one or more unmanaged payees 110. An unmanaged payee 110 is a payee about whom a payment service provider 102 does not maintain information to aid in the handling of remittance. In an exemplary embodiment of the invention, an unmanaged payee 110 and the payment service provider 102 do not necessarily have a relationship (indicated in FIG. 1 by the dotted line connecting the unmanaged payee 110 to the network 106). FIG. 1 also depicts one or more managed payees 112. A managed payee 112 is a payee about whom the payment service provider 102 maintains information that enables remittance to that managed payee to be handled in some improved and/or optimal fashion, such as electronically via the network 106 and/or via another network. Although the exemplary embodiment of FIG. 1 shows a managed payee in communication with the network 106, it is not required that each managed payee communicate via the network 106, or via any other specific network.

The information maintained by the payment service provider 102 for a managed payee 112 typically includes one or more account schemes for improved reliability of Accounts Receivable posting at the managed payee 112, account ranges for remittance center identification, other information for remittance center identification, preferred credit form (paper or electronic), preferred remittance advice form (paper or electronic), and electronic links for delivery of electronic credits and/or electronic remittance advice. A managed payee 112 provides this information to the service provider 102. The received information is typically stored in a managed payee database. An electronic payee is a managed payee about whom a service provider maintains information enabling remittance to be issued electronically. A merchant is a payee that issues bills for services rendered or goods purchased. Thus, a merchant is a special class of payee, a payee that issues bills. A merchant can be an unmanaged merchant, a managed merchant, or an electronic merchant.

Remittance advice is a description of a credit that allows proper payment posting to a specific account, or sub-account, in a payee's Accounts Receivable ledger. Remittance advice may be tightly coupled with an instrument used to accomplish the credit (e.g., information printed in a memo field on a check or draft, or information included in a field in or appendage to an electronic funds transfer file transmitted over a network linking financial institutions), or it may be somewhat decoupled from the credit, such as a paper document delivered to a payee, separate from a credit, or an electronic file transmitted directly to the payee separate from a credit. Remittance advice typically includes at least information identifying a payor, information identifying the payor's account with the payee, and a payment account.

Also shown in FIG. 1 are one or more financial institutions 114. At least one of the financial institutions 114 maintains one or more demand deposit accounts belonging to the payment service provider 102. In an exemplary embodiment of the invention shown in FIG. 1, a financial institution 114 maintaining a payment service provider's 102 account communicates with the payment service provider 102 via one of the family of networks represented by network 106. However, the present invention does not require that each financial institution 114 communicate via the network 106, as shown in FIG. 1, rather the financial institution may communicate with one or more payment service providers 102, subscribers 104, payees 110-112, or other entities via other communication means appreciable by one of ordinary skill in the art. Also, each of the subscribers 104 may be associated with at least one respective demand deposit account maintained at one of the financial institutions 114. Furthermore, each of the unmanaged payees 110 and each of the managed payees 112 may be associated with at least one respective demand deposit account maintained at one of the financial institutions 114.

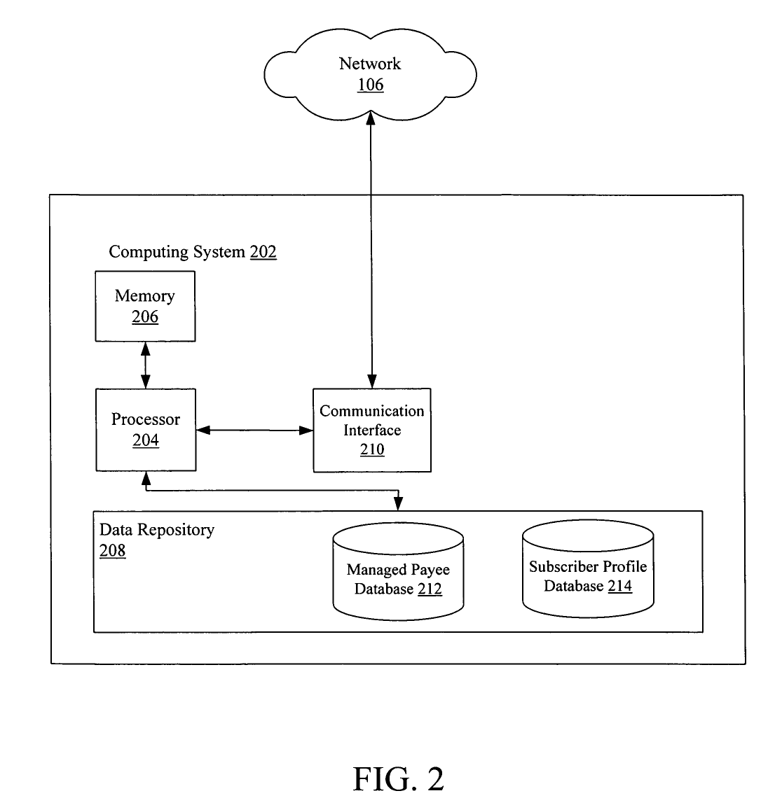

FIG. 2 shows a computing system to support the payment service of the present invention maintained by the payment service provider. According to the exemplary embodiment of the invention shown in FIG. 2, the computing system 202 includes at least one processor 204 configured to execute programming instructions stored in at least one memory 206. The computing system 202 also includes a data repository 208 configured to store data necessary to provide the payment service. Also shown in FIG. 2 is at least one communication interface 210 for transmitting and receiving data at least via the network 106. As desired, a communication interface 210 also transmits and/or receives data via one or more networks other than the network 106.

The data repository 208 includes a managed payee database 212 that stores information identifying and associated with managed payees. A managed payee database 212 includes information identifying each managed payee known to a payment service provider, along with the information received from each managed payee. The data repository 208 also includes a subscriber profile database 214 that stores information identifying and associated with subscribers. Other information may also be stored in the data repository 208, though not shown in FIG. 2. The subscriber profile database 214 may include, for each subscriber, a subscriber's name, address, funding account information and/or other data associated with a particular subscriber. In an exemplary embodiment of the invention, the subscriber profile database 214 may also include a subscriber's phone number and e-mail address. Also, as desired, the subscriber profile database 214 may include other types of information associated with a subscriber.

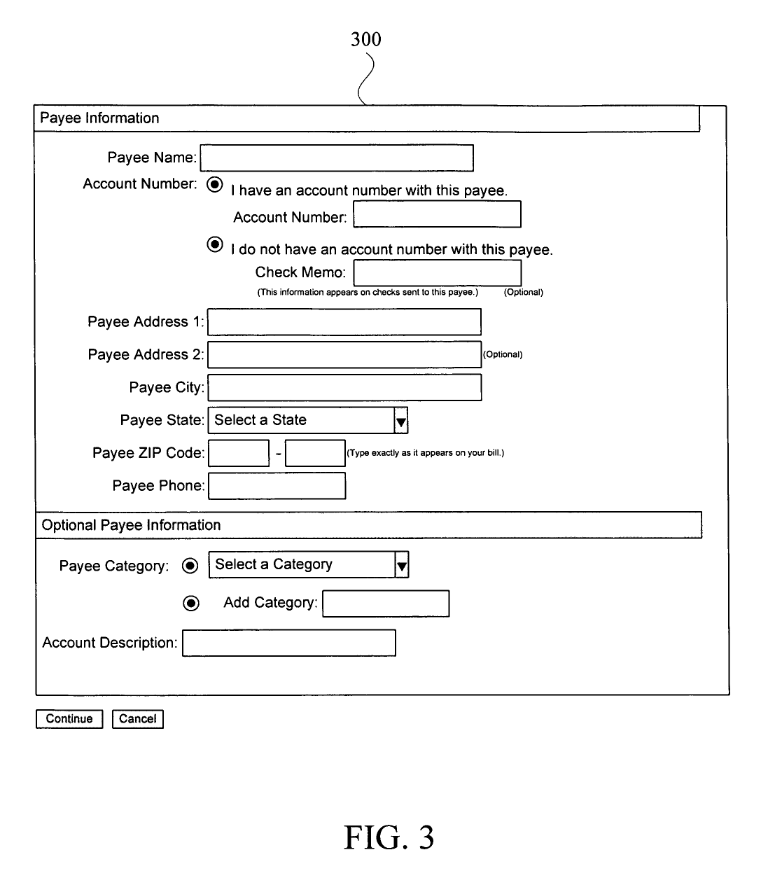

FIG. 3 depicts a user interface 300 for payee set-up by a subscriber accessible through the system shown in FIG. 1. As shown in the user interface 300 of FIG. 3, a subscriber provides information identifying a payee. This may include a payee name, a payee account number (if applicable), payee address, payee zip code, payee phone number (if available), etc. In alternative embodiments of the invention the information identifying a payee provided by a subscriber may include a payee e-mail address (if available) as well as other information capable of identifying the payee and/or allowing for future transactions with that payee. Beyond this basic information needed to identify and contact a payee, there may be, as desired, provisions for entering additional information, such as payee category, and a description or comments. The exemplary user interface 300 of FIG. 3 includes fields where users input information including the payee's address, phone, associated payee category (e.g., utility, vendor, bank etc.), account number of a payor(s) to be associated with the particular payee.

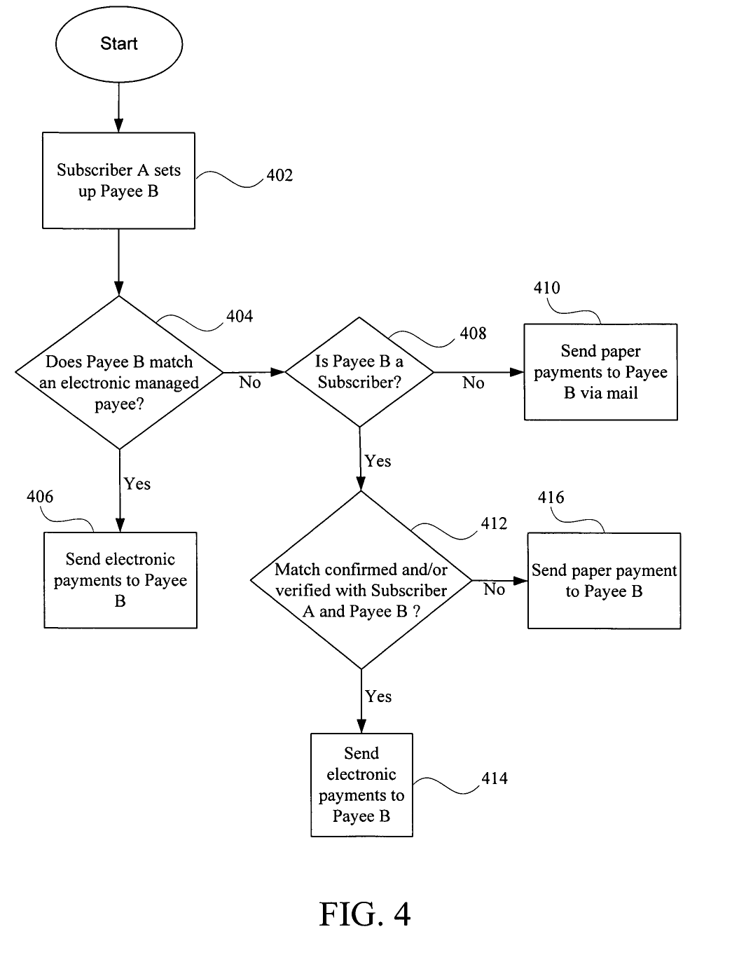

FIG. 4 is a flow diagram of a subscriber to payee cross-pollination process in accordance with an exemplary embodiment of the present invention. Such a cross-pollination process (described in FIGS. 4-6) may be implemented on the systems described above in reference to FIGS. 1 and 2. As shown in the overall exemplary cross-pollination process of FIG. 4, because the payment service provider maintains information identifying subscriber funding accounts, an electronic payment may be made to any payee that is also a subscriber for which the payment service provider maintains funding account information. In step 402 a subscriber, in this case subscriber A, sets up a new payee, referred to as payee B. This set up includes subscriber A providing identifying information identifying and associated with payee B, as discussed above with reference to the user interface shown in FIG. 3.

At step 404 the payment service provider determines if payee B is a managed payee that accepts electronic payments. In the exemplary embodiment of the invention shown in FIG. 4 this determination is conducted by the payment service provider determining if the payee information supplied by the subscriber A matches information stored in the managed payee database. Further, the techniques for determining if payee B is a managed payee disclosed in U.S Pat. No. 6,327,577, which is incorporated by reference in its entirety as if set forth fully herein, may, as desired, be utilized in determining if payee B is a managed payee that accepts electronic payment. If the results of the processing of step 404 are that payee B is an electronic managed payee, operations continue with step 406 in which the payment service provider will send electronic payments to the payee B based upon information included in the managed payee database.

If in step 404 it is determined that payee B is not an electronic managed payee, operations continue with step 408 in which the payment service provider determines if payee B is an existing subscriber. In the exemplary embodiment of the invention shown in FIG. 4 this determination is conducted by the payment service provider determining if the payee information supplied by subscriber A matches information stored in a subscriber profile database. If not, operations continue with step 410 in which payments to payee B will be sent by paper. If it is determined that payee B is an existing subscriber, operations continue with step 412 in which the payment service provider confirms the determination of step 408 and/or verifies that payee B wishes to receive electronic payments. If the determination of step 408 is confirmed and/or verified, operations continue with step 414 in which electronic payments are made to payee B. If the determination of step 408 is not confirmed and/or verified, operations continue with step 416 in which payments to payee B are made by paper.

According to an exemplary embodiment of the invention, one way of identifying payee B as an existing subscriber is by an exact matching of the name and address supplied by subscriber A with information stored in the subscriber profile database. As desired, the initial match could be based on exact name alone, although this could potentially lead to ambiguity (such as with a Senior and a Junior at a same address). Also as desired, the initial match could be based upon address alone. However, because the address of payee B supplied by subscriber A may contain data entry errors or otherwise lead to ambiguity, this address could be converted to a zip+9 format to be used in the matching process. In another alternative, one or both of a payee e-mail address and/or phone number could be used independently, or in combination with a name and/or address, as part of the matching process.

In yet another alternative for determining if payee B is a subscriber, a third-party consumer identification service could be used. Such a service could either return normalized data to be used in the matching process, or return a unique consumer identification number based on some set of parameters (possibly including name and address). For example, a payee address might be supplied by a subscriber as “123 Beachwood Street”, while an address of a matching subscriber might be included in the subscriber profile database as “123 Beach Wood St”. In such a situation, address normalization might improve the matching process. Other alternatives for identifying a payee as a subscriber may be implemented in alternative embodiments of the invention.

Regarding the confirmation and verification introduced above, for obvious reasons of risk and liability, it would be undesirable to send payments to a wrongly identified subscriber. It is also possible that a correctly matched payee that is also a subscriber might not want to receive electronic payments, or might want to receive electronic payments into a particular account other than that subscriber's funding account. Thus, it is desirable to obtain payee verification of the acceptability of electronic payment, as well as the desired account into which to make electronic payments. Confirmation of a correct match with subscriber A could be done in real time, could be done via e-mail, could be done via phone, or even could be done via traditional postal delivery. No matter the form of communication, the confirmation identifies the matched payee by the information stored in the subscriber profile database, and asks the subscriber adding that payee if the match is correct.

Similarly, the verification performed with the matched subscriber that is a payee could be via any number of communication channels known to the payment service provider based upon information included in the subscriber profile database. The verification communication asks the matched subscriber if he or she wishes to received electronic payments into the identified funding account. As desired by a matched subscriber, at this point he or she may identify an alternate account into which to make electronic payments. In such a case, the payment service provider would store this information. The confirmation and/or verification process can be, as desired, completed in either a parallel or a serial manner with an initial payment to the payee.

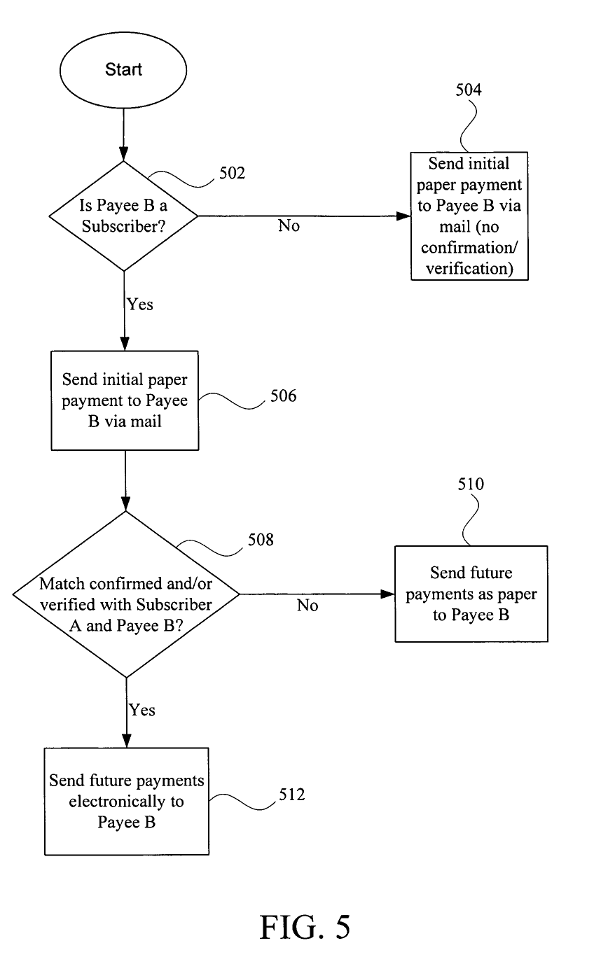

FIG. 5 shows an exemplary embodiment of the subscriber to payee cross-pollination process where the confirmation and verification process takes place in parallel with an initial payment made via paper, and then future payments may be sent electronically upon successful confirmation and verification. As shown in FIG. 5, at step 502 the payment service provider determines if payee B is a known subscriber. If not, the initial payment, at step 504 is sent to payee B via mail. If at step 502 payee B is determined to be a known subscriber, operations continue with step 506, in which the initial payment to payee B is also sent via mail. However, following step 506, the confirmation and/or verification of step 508, discussed above with reference to FIG. 4, are performed. If the confirmation and/or verification of step 508 fails, operations continue with step 510 in which future payments are sent as paper. However, if the confirmation and/or verification of step 508 is successful, the future payments are sent electronically, as shown in step 512.

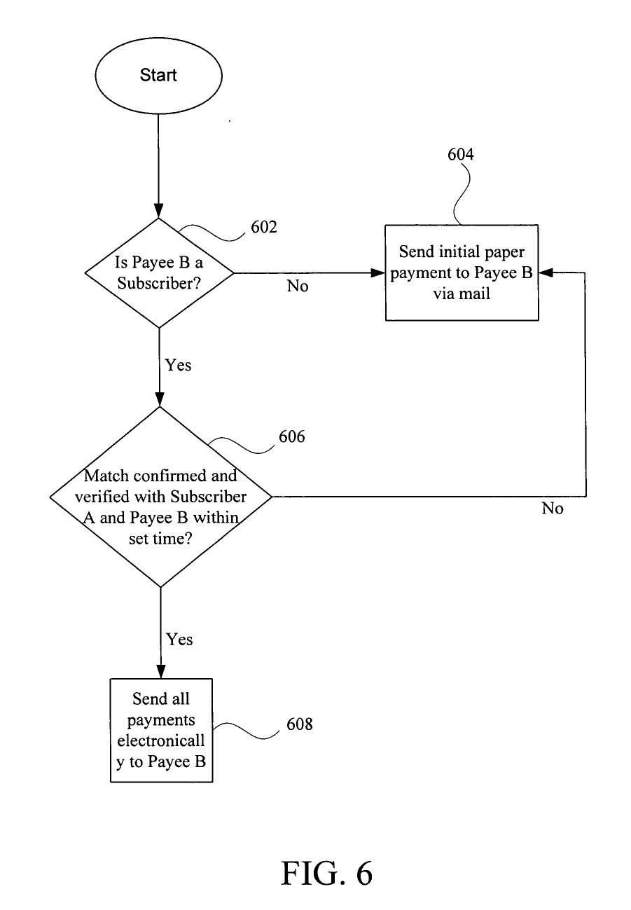

FIG. 6 shows an alternative embodiment of the invention, where the verification and confirmation process may take place prior to making a payment, thus delaying the initial payment until confirmation has been received or until a predetermined delay period has elapsed. It may be desirable, though not necessary, that the payor's approval for a delay be obtained, or, as desired, the processing of FIG. 6 could be restricted to future dated payments with adequate lead time.

As shown in FIG. 6, at step 602 the payment service provider determines if payee B matches a known subscriber. If not, the initial payment, at step 604 is sent to payee B via mail. If at step 602 payee B is determined to be a subscriber, operations continue with step 606 where it is determined if the match has been confirmed and/or verified within a set period of time. If not, operations continue with step 604, discussed above. If, however, the determination in step 606 is that the match has been confirmed and/or verified, operations continue with step 608 in which all payments to payee B are sent electronically.

In an optional implementation, authorization for a subscriber to become an electronic payee could be obtained during initial registration of that subscriber, eliminating the need for the validation communication with a matched subscriber. Alternatively, the payment service provider could execute a mass verification process to establish existing subscribers as payees prior to any payments being issued to them. As a result, if a subscriber is matched as a payee, it would be necessary to obtain account information related to that subscriber in order to make electronic payments to that subscriber A verification process would confirm 1) their desire to receive payments electronically and 2) that they either want to receive these in the already provided funding account or that they want to receive payments in another account (in which case they would be required to provide the account).

In order to reduce business risk and to reduce claims or exception processing, it is desirable to confirm that the matching processing has resulted in a match to a current and active bank account. This confirmation could be based upon an analysis of recent activity, including payment activity or claims activity, or other techniques such as account confirmation, pre-note processing, and/or an external database search. Recent payment activity by a subscriber, based on the funding account listed in the subscriber profile database, is a reliable indicator that the account is active. A lack of claims activity related to the subscriber's account for these recent payments is also an additional indicator that the account is active. Recent successful account confirmation of the funding account is yet another indicator. An account confirmation process may also be triggered, if the payment service provider has a new account for which the payment service provider has no history. As desired, the pre-note process for confirming the subscriber funding account may also be utilized to determine if the account is active. As for utilizing external databases of accounts, this option is more costly than the others. Further, typically these databases provide information on known “bad” accounts, rather than known “good” accounts. All, or only a portion of, these confirming steps could be, as desired, utilized in order to manage risk and minimize claims or exception processing, independent of a dollar value of any particular payment.

Once a payee is matched as a subscriber, that payee can be, as desired, added to the managed payee database. Alternatively, the matched subscriber could be flagged in the subscriber profile database as a payee. Still further, as desired, a new database, not shown in the figures, could be maintained that includes only those subscribers matched as payees, referred to as the “subscriber/payee database.”

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for processing payee information, comprising:
storing information identifying a first subscriber of an electronic payment service;
receiving, from a second subscriber, information identifying an intended payee of the second subscriber;
determining that the first subscriber and the intended payee of the second subscriber are the same entity; and
converting the first subscriber to an electronic payee.

2. The method of claim 1, wherein determining that the first subscriber and the intended payee of the second subscriber are the same entity is based upon at least a portion of the stored first subscriber identifying information matching at least a portion of the received payee identifying information.

3. The method of claim 1, further comprising normalizing the received payee information prior to determining that the first subscriber and the intended payee of the second subscriber are the same entity.

4. The method of claim 1, further comprising confirming the determining with the second subscriber.

5. The method of claim 1, further comprising verifying the determining with the payee.

6. The method of claim 5, wherein the verifying includes identifying a deposit account to credit electronically.

7. The method of claim 1, further comprising receiving a request to pay the intended payee on behalf of the second subscriber; and issuing an instruction to electronically credit a deposit account based upon the stored first subscriber information.

8. The method of claim 7, wherein the request is received from a consumer service provider associated with the second subscriber.

9. The method of claim 7, wherein the payee information and the request are received together.

10. The method of claim 1, wherein determining that the first subscriber and the intended payee of the second subscriber are the same entity includes:
responsive to receiving the information identifying an intended payee, identifying the first subscriber as a candidate match to the intended payee,
requesting a confirmation of the acceptability of converting the first subscriber to an electronic payee, and
receiving the confirmation of the acceptability of converting the first subscriber to an electronic payee.

11. The method of claim 10, wherein requesting and receiving a confirmation that the first subscriber and the payee are the same entity occurs in parallel with directing an initial credit to a deposit account.

12. A method for processing subscriber information of the payment service provider, comprising:
storing information identifying a first subscriber of an electronic payment service provider;
requesting a confirmation of the acceptability of converting the first subscriber to an electronic payee;
receiving the confirmation of the acceptability of converting the first subscriber to an electronic payee; and
responsive to receiving the confirmation, converting the first subscriber to an electronic payee.

13. The method of claim 12, further comprising sending electronic payments on behalf of a second subscriber to the electronic payee.

14. The method of claim 12, wherein receiving the confirmation of the acceptability of converting the first subscriber to an electronic payee includes receiving the confirmation from a third party consumer identity service.

15. The method of claim 12, further comprising associating a deposit account with the electronic payee.

16. The method of claim 15, wherein requesting and receiving a confirmation that the first subscriber and the payee are the same entity occurs in parallel with directing an initial credit to the deposit account.

17. The method of claim 12, wherein receiving the confirmation of the acceptability of converting the first subscriber to an electronic payee includes verifying the acceptability of converting the first subscriber to an electronic payee with the first subscriber.

18. The method of claim 17, wherein the verifying includes identifying a deposit account to credit electronically.

19. A system for processing payee information, comprising:
a memory configured to store information identifying a first subscriber of an electronic payment service; and
a processor configured to receive, from a second subscriber, information identifying an intended payee of the second subscriber, and wherein the processor contains programmed logic to execute software instructions for:
determining that the first subscriber and the intended payee are the same entity, and
converting the first subscriber to an electronic payee.

20. The system of claim 19, wherein the memory comprises at least one of a subscriber profile database, a managed payee database, and a subscriber/payee database.

21. The system of claim 19, wherein the determining is made based upon at least a portion of the stored first subscriber identifying information matching at least a portion of the received payee identifying information.

22. The system of claim 19, wherein the received payee information is normalized prior to determining that the first subscriber and the intended payee are the same entity.

23. The system of claim 19, wherein the processor contains software instructions for receiving a confirmation that the first subscriber and the intended payee are the same entity from the second subscriber.

24. The system of claim 19, wherein the processor contains software instructions for verifying the determining with the payee.

25. The system of claim 24, wherein the verifying includes identifying a deposit account to credit electronically.

26. The system of claim 19, wherein the software instructions for determining that the first subscriber and the intended payee are the same entity executed by the processor include: responsive to receiving the information identifying an intended payee, identifying the first subscriber as a candidate match to the intended payee, requesting a confirmation of the acceptability of converting the first subscriber to an electronic payee, and receiving the confirmation of the acceptability of converting the first subscriber to an electronic payee.

27. The system of claim 19, wherein the stored first subscriber information comprises information identifying a deposit account associated with the first subscriber and the received information identifying an intended payee of the second subscriber excludes information identifying the deposit account, and wherein the processor comprises software instructions for receiving a request for the payment service provider to pay the payee on behalf of the second subscriber, and issue an instruction to electronically credit the deposit account based upon the stored first subscriber information.

28. The system of claim 19, wherein the request is received from a consumer service provider associated with the second subscriber.

29. The system of claim 19, wherein the payee information and the request are received together.
